(19) United States
(12) Patent Application Publication
(10) Pub. No.: US 2006/0210198 A1
(43) Pub. Date: Sep. 21, 2006

(54) Optical-character-recognition system and optical-character-recognition method

(75) Inventors: Yoshiko Suenaga, Kanagawa-ken (JP); Hiroki Miyachi, Kanagawa-ken (JP); Kouichi Mase, Chiba-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/290,091

(22) Filed: Nov. 29, 2005

(30) Foreign Application Priority Data
Mar. 16, 2005 (JP) 2005-075783

(51) Int. Cl. G06K 7/10

(52) U.S. Cl. 382/321

(57) ABSTRACT

An OCR system includes an operation-and-display unit having an operation unit that receives input-operation information transmitted from a user and a display unit that visually presents information to the user that are integrated with each other, a read unit that converts information provided on a document into image information, an OCR-processing unit that acquires character information by OCR processing for the image information, a job-control unit that controls operations performed by the read unit and the OCR-processing unit, and a control unit that controls the above-described units. The control unit controls the display unit for showing an OCR result for a first page and an image scanned by the read unit so that the user can compare the OCR result to the scanned image. Where the input-operation information includes a request for cancellation, the scanning and the OCR processing are stopped.

### BACKGROUND OF THE INVENTION

1. Field of the Invention

The present invention relates to an optical-character-recognition system and an optical-character-recognition method, and particularly relates to an optical-character-recognition system and an optical-character-recognition method that can inform a user of the rate of optical-character recognition without delay, when the optical-character-recognition rate becomes low.

2. Description of the Related Art

As an example of known optical-character-recognition (hereinafter referred to as OCR) systems and OCR methods, Japanese Unexamined Patent Application Publication No. 2003-208564 discloses a technology adapted to automatically stop performing OCR processing, when a breakage of a document subjected to OCR processing is detected during character recognition is performed.

The above-described OCR system and OCR method can automatically stop performing OCR processing so as to prevent the OCR system or an OCR device from being damaged by the document to be OCR-processed, however, the above-described OCR system and OCR method cannot automatically stop performing OCR processing due to a flaw in read settings made by a user.

That is to say, if there was a flaw in read settings made by a user using the known OCR system and OCR method, the user does not notice the flaw until after the entire OCR objects are OCR-processed and the user sees the OCR result. Therefore, after the OCR processing is completed, the user has to correct errors one by one by referring to the recognition result presented on a correction screen. Otherwise, the user has to cancel the entire recognition result, set a document to a scanner again, and perform scanning and/or OCR processing again, for example. That is to say, the user has to correct the errors, or perform the OCR processing again. Particularly, if there are many documents to be OCR-processed, it takes great trouble and time for the user to perform the above-described correction, or perform the OCR-processing again.

### SUMMARY OF THE INVENTION

The present invention is made to overcome the above-mentioned disadvantages and it is an object of the present invention to provide an OCR system and an OCR method being capable of informing a user of a decrease in the rate of optical-character recognition without delay and/or a decrease being caused by a flaw in read settings, which reduces the time and trouble required for performing scanning and/or OCR processing again.

Accordingly, an optical-character-recognition system according to the present invention includes an operation unit configured to receive input-operation input from a user, a display unit configured to visually present information to the user, a read unit configured to perform conversion processing, so as to convert information provided on at least one document to image information, an optical-character-recognition unit configured to perform character-information-acquisition processing, so as to acquire character information by subjecting the image information to optical-character-recognition processing, a job-control unit configured to control an operation performed by each of the read unit and the optical-character-recognition unit, and a control unit configured to control the operation unit, the display unit, the read unit, the optical-character-recognition unit, and the job-control unit, wherein the control unit performs control so that the display unit shows an image based on the image information and the character information obtained on the basis of the image information representing a first page of the document in a predetermined manner. Wherein in case of receiving the input-operation information requesting for cancellation from the operation unit, the control unit performs control so that the read unit stops performing the conversion processing and the optical-character-recognition unit stops performing the character-information-acquisition processing.

In addition, according to another embodiment of the present invention, the control unit is configured to perform control so that the display unit shows an image on the basis of the image information and an image on the basis of the character information in parallel. According to further embodiment of the present invention, in a event that a value of a character-recognition rate for a predetermined page is lower than a threshold value representing a predetermined character-recognition rate, the control unit is configured to perform control so that the display unit highlights the area and/or character corresponding to the character-recognition-rate value lower than the threshold value, the area and/or character being included in the predetermined page.

According to another aspect of the present invention, an optical-character-recognition method includes the steps of, converting information including at least character information, provided on a document, to image information, performing optical-character-recognition processing so as to acquire character information on the basis of the image information until an input-operation information including a request for cancellation is received, and stopping the converting step and the optical-character-recognition step without delay in a event that the input-operation information including the request for cancellation is received.

As described above, the optical-character-recognition system and optical-character-recognition method according to the present invention allow informing a user of a decrease in the rate of optical-character recognition without delay, the decrease being caused by a flaw in read settings. Therefore, it becomes possible to reduce the time and trouble required for performing scanning and/or OCR processing again.

### BRIEF DESCRIPTION OF THE DRAWINGS

FIG. 1 schematically shows a basic functional configuration of an OCR system according to an embodiment of the present invention;

FIG. 2 is a sequence chart illustrating an example series of processing procedures performed by the OCR system, where no cancellation request is issued (under normal conditions); and

FIG. 3 is a sequence chart illustrating an example series of processing procedures performed by the OCR system, where the cancellation request is issued (when cancelled).

### DESCRIPTION OF THE PREFERRED EMBODIMENTS

Hereinafter, optical-character-recognition (hereinafter referred to as OCR) systems and OCR methods according to embodiments of the present invention will be described with reference to the attached drawings.

The term “OCR system” denotes a system configured to acquire image information about a document to be read, perform OCR processing for the acquired image information, and perform character recognition.

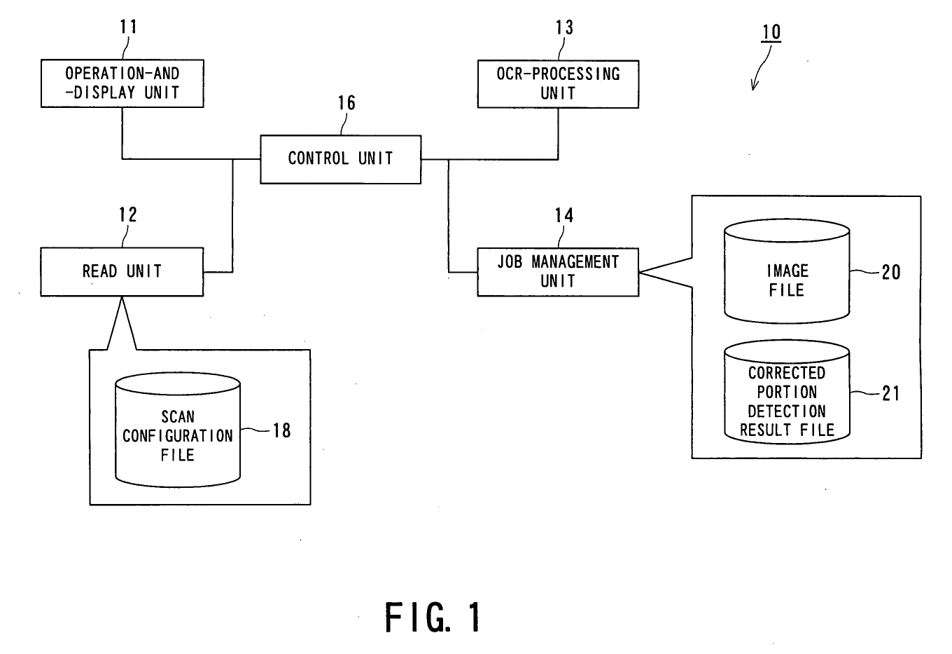

FIG. 1 schematically shows a basic functional configuration of an OCR system 10 according to an embodiment of the present invention.

As shown in FIG. 1, the OCR system 10 includes an operation-and-display unit 11 including an operation element configured to receive (accept) operation (input-operation) input from a user, which includes OCR-start-operation, cancellation-operation and so forth, and a display element configured to visually present information to the user. The OCR system 10 further includes a read unit 12 configured to convert information provided on a document (including at least one sheet of paper) into image information, an OCR-processing unit 13 configured to acquire character information by performing OCR processing for the image information, a job-control unit 14 configured to control an operation performed by each of the read unit 12 and the OCR-processing unit 13, and a control unit 16 configured to control the operation-and-display unit 11, the read unit 12 and the OCR-processing unit 13, and the job-control unit 14.

The operation element of the operation-and-display unit 11 has a function of receiving input-operation input by the user such as scan-start-request-operation, cancellation-request-operation or the like. The operation element also has a function of generating information (hereinafter, referred to as input-operation-information) indicating input-operation such as scan-start-request-operation, cancellation-request-operation or the like. Information about the details on the input-operation transmitted to the operation element is transmitted to the control unit 16, as input-operation information.

The display element of the operation-and-display unit 11 has a function of visually presenting information (hereinafter, referred to as display information) to the user, which includes information regarding the result of OCR processing performed for each page, for example. Therefore, when the display element receives display information transmitted from the control unit 16, the display element can display the image corresponding to the display information.

In practice, each of the operation element and display element of the operation-and-display unit 11 may be provided in the OCR system 10, as an independent processing unit.

The read unit 12 has a scan function. Herein, the scan function resides that a function of reading information provided on a document including at least one sheet of paper (at least one page) and converting the read information into image information.

Further, the read unit 12 acquires scan-setting information indicating conditions under which the document information is converted (scanned) into the image information, where the image information includes, for example, information about a document type, a density, a background-adjustment value, sharpness, and so forth.

The scan-setting information is stored in advance, as electronic information including a scan-setting file 18, for example. The read unit 12 can acquire the scan-setting information by referring to the scan-setting file 18 storing the scan-setting information.

Note that the scan-setting information may be input by the user. In that case, the control unit 16 generates the scan-setting information based on the input-operation information generated at the operation-and-display unit 11 and then transmitted from the operation-and-display unit 11. Next, the control unit 16 transmits to the read unit 12 so that the read unit 12 acquires the scan-setting information.

The OCR-processing unit 13 has an OCR function adapted to acquire character information from image information. Therefore, the OCR-processing unit 13 can acquire character information on the basis of image information by performing OCR processing.

The job-control unit 14 has a function of controlling each of a series of processing procedures performed by the read unit 12 and those performed by the OCR-processing unit 13, as a single job. Therefore, the job-control unit 14 can receive the scan-start-input-operation information transmitted from the control unit 16 and control each of read (scan) processing performed by the read unit 12 and OCR processing performed by the OCR-processing unit 13, in a single job.

Further, when the job-control unit 14 starts generating jobs and a single-page worth of jobs are generated, the job-control unit 14 starts executing the jobs. When the jobs are started, the job-control unit 14 transmits a signal to the control unit 16, so as to inform the control unit 16 that the jobs are started. When the entire-pages worth of jobs are generated and all of the jobs are finished, the job-control unit 14 transmits a signal to the control unit 16, so as to inform the control unit 16 that all of the jobs are finished.

Furthermore, the job-control unit 14 has a function of controlling read image information and an OCR-processing result. That is to say, the job-control unit 14 can read and/or store image information read by the read unit 12 from/into a data-storage area provided in the job-control unit 14, or a predetermined data-storage area (not shown), as electronic information such as an image file 20, for example. In addition, the job-control unit 14 can read and/or store character information (hereinafter referred to as OCR information) from/into the data-storage area, or the predetermined data-storage area, as electronic information such as an OCR file 21. Herein, the OCR information is obtained by the OCR-processing unit 13, as a result of OCR processing. The job-control unit 14 receives the image information and the OCR information transmitted from the control unit 16.

The control unit 16 has a function of controlling the operation-and-display unit 11, the read unit 12, the OCR-processing unit 13, and the job-control unit 14 so that information can be transmitted and received among the above-described units 11 to 14.

More specifically, the control unit 16 receives input-operation information transmitted from the operation element of the operation-and-display unit 11. Then, the control unit 16 controls the display element of the operation-and-display unit 11, the read unit 12, the OCR-processing unit 13, and the job-control unit 14 according to the details on the input-operation information. Subsequently, the necessary processing corresponding to the details on the input-operation information is performed.

Further, the control unit 16 receives image information transmitted from the read unit 12. Herein, the read unit 12 acquired the image information by reading (scanning) a document. The image information is transmitted to the job-control unit 14, and the job-control unit 14 stores the image information in a predetermined place.

Furthermore, the control unit 16 receives information about the result of OCR processing performed by the OCR-processing unit 13, i.e., the OCR information. The OCR information is transmitted to the job-control unit 14, and the job-control unit 14 stores the OCR information in a predetermined storing area.

Upon receiving the image information and the OCR information, the control unit 16 generates display information based on the transmitted image information and OCR information so that the display information and the OCR information are shown in parallel on the display element, and transmits the generated display information to the operation-and-display unit 11. Subsequently, the OCR system 10 can make the display means such as the display element of operation-and-display unit 11 produce a display image of the image obtained by the scanning and the OCR result.

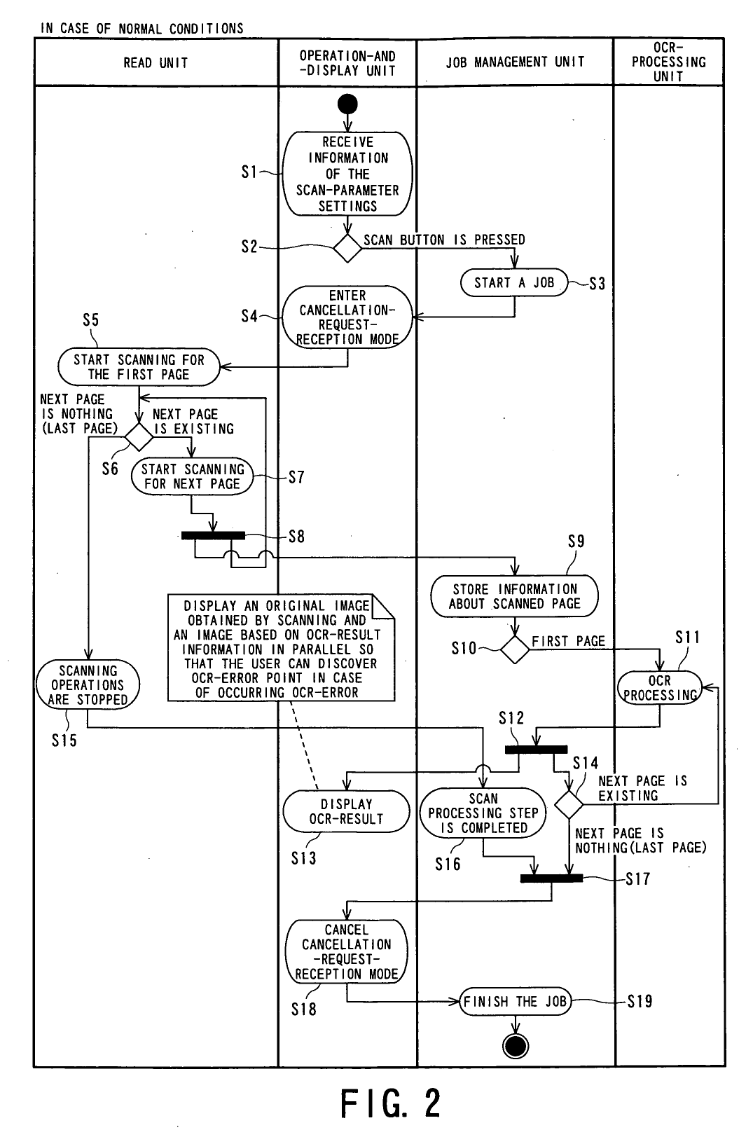

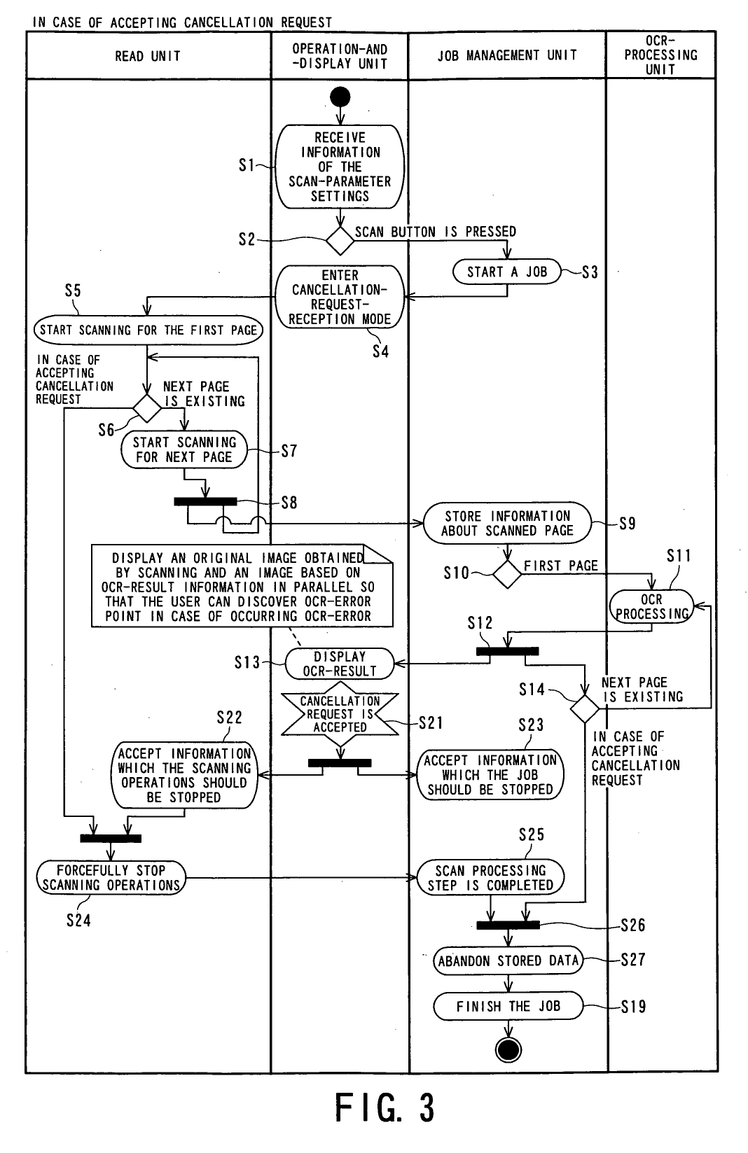

In addition, the control unit 16 receives a signal transmitted from the job-control unit 14, when the signal indicates that the generation of a job is started or finished, and generates control information used for controlling each of the processing units, as required. The control unit 16 can keep track of the flow of the scanning and the OCR processing. Therefore, upon receiving the job-generation-start signal, the control unit 16 generates control information adapted to make the operation-and-display unit 11 enter the cancellation-acceptable state and transmits the control information to the operation-and-display unit 11, and generates control information adapted to make the read unit 12 start scanning and transmits the control information to the read unit 12. Note that the details on the scanning and the OCR processing performed in the OCR system 10 will be described later with reference to FIGS. 2 and 3.

According to the above-described OCR system 10, an image (image information) obtained by scanning and an OCR result (OCR information) are shown in parallel on the display element of the operation-and-display unit 11 at the time when OCR processing for the first page is finished.

Therefore, it becomes possible to inform a user of a decrease in the rate of optical-character recognition without delay, the decrease being caused by a flaw in read settings, and reduce the time and trouble required for performing the scanning and/or the OCR processing again.

Further, in the event that the OCR rate decreases due to the flaw in the read settings, the OCR processing can be cancelled when the scanning is performed. Therefore, it becomes possible to prevent the OCR system 10 from being placed under a heavier load than is necessary.

Furthermore, according to the above-described OCR system 10, the OCR system 10 is configured so as to show the image (image information) obtained by the scanning and the OCR result (OCR information) in parallel, however, the OCR system 10 is not necessarily configured so as to show the image (image information) obtained by the scanning and the OCR result (OCR information) in parallel. After all, the OCR system 10 may be configured so that the OCR information may be presented to the user according to another method, as long as the OCR information can be compared to the image information.

According to the above-described method, in the event that the rate of character recognition for a predetermined page is lower than a threshold value set in advance representing a predetermined character-recognition rate set in advance, the control unit 16 generates display information, so as to instruct to highlight an area and/or a character, where the numerical value of a character-recognition rate of the area and/or the character is lower than the above-described threshold value.

According to still another method wherein the OCR information can be compared to the image information, the OCR system 10 may further include an alarm unit so that the control unit 16 performs control so that the alarm unit is operated when the character-recognition rate for a predetermined page is low. In that case, an alarm can be issued, where the value of the character recognition rate for the entire page is lower than a predetermined value (threshold value).

Further, the OCR system may be configured so that the user can make display settings via the operation-and-display unit 11, so as to show the image information and the OCR information in parallel on the display element of the operation-and-display unit 11, when the OCR processing for the first page is finished. Hereinafter, the above-described display settings will be referred to as confirmation-display settings.

For example, at least one item can be set by using the confirmation-display settings, where the item is selected from among a display-time item, a display-page-number item, a specific-part enlargement item, an entire-page reduction item, and a display-change mode item. Herein, the display-change mode includes a manual mode adapted to perform display change manually and an automatic mode adapted to perform the display change automatically.

Since the control unit 16 generates display information shown on the display element of operation-and-display unit 11 based on the details on the confirmation-display settings, the OCR system 10 can change a display image to that of the next image and/or the OCR result according to a display time and/or a page number set in advance, enlarge a specific part, reduce a page so that the entire image thereof can be seen, and switch between the manual mode and the automatic mode without restraint.

In addition, in the above-described OCR system 10, the control unit 16 may be configured to control the display element so that an image of the OCR result obtained for the next page is automatically produced after a predetermined time period elapses, or the display element switches between the manual mode and the automatic mode at an appropriate time.

Where the OCR system 10 is configured, so as to be able to switch between the manual mode and the automatic mode at an appropriate time, the OCR system 10 may include a user interface configured to receive a request “cause display to pause” and a request “start display again”, where the above-described requests are transmitted to the operation-and-display unit 11 and the control unit 16 may be configured to control the display element of the operation-and-display unit 11 so that the display element causes the display to pause (only the display pauses while the scanning and the OCR processing are continued) and starts the display again.

Further, the above-described OCR system 10 may include a user interface configured to receive a request “discontinue display”, where the image information and the OCR information are shown in parallel on the display element when the OCR processing for the first page is finished. Furthermore, the control unit 16 may be configured to perform control so that the operation-and-display unit 11 receives the request “discontinue display” and discontinues the display of the image information and the OCR information.

For making the present invention more effective, the operation-and-display unit 11 may preferably be provided at such a position that the user can refer to information shown on the display element of the operation-and-display unit 11, where the user subjects the information to scanning by using the read unit 12.

Further, the OCR system 10 may not include the operation-and-display unit 11, the read unit 12, the OCR-processing unit 13, the job-control unit 14, and the control unit 16 that are shown in FIG. 1, as a single apparatus. That is to say, the OCR system 10 may include each of the read unit 12, the OCR-processing unit 13, the job-control unit 14, and the control unit 16, as an independent device.

In the OCR system 10, the control unit 16 may be configured to control the job-control unit 14, as below. Namely, upon receiving a cancellation request, the job-control unit 14 generates display information adapted to ask the user whether or not OCR information that had already been generated should be abandoned and transmits the display information to the operation-and-display unit 11. Further, in the event that the control unit 16 receives operation-input information indicating that the OCR information should be abandoned, transmitted from the operation-and-display unit 11, the control unit 16 controls so that the job-control unit 14 abandons the image information and the OCR information. On the other hand, in the event that the control unit 16 receives operation-input information indicating that the OCR information should be stored (not abandoned), transmitted from the operation-and-display unit 11, the control unit 16 controls so that the job-control unit 14 stores the image information and the OCR information in a predetermined storing area, for example, provided on the job-control unit 14. Thus, the job-control unit 14 holds the existing information.

Next, an OCR method according to an embodiment of the present invention will be described.

The OCR method is achieved by executing a job generated by an OCR system according to an embodiment of the present invention, such as the OCR system 10.

Each of FIGS. 2 and 3 is a sequence chart illustrating the flow of processing procedures performed by the OCR system. FIG. 2 illustrates the flow of example processing procedures performed, where no cancellation request is issued (hereinafter referred to as being under normal conditions). FIG. 3 illustrates the flow of example processing procedures performed, where the cancellation request is issued (hereinafter referred to as when cancelled). Shown in FIGS. 2 and 3, the settings on scan parameters are made by the user.

Under normal conditions, a series of processing procedures corresponding to steps S1 to S19 are performed in sequence, as shown in FIG. 2. First, the operation-and-display unit 11 receives (accepts) input-operation regarding the scan-parameter settings, as a preparation for the job-control unit 14 starting the job generation, at step S1.

After the operation-and-display unit 11 receives the input-operation of the scan-parameter settings and then generates information (hereinafter, referred to as the scan-parameter setting information) regarding input-operation of scan-parameter settings, the processing corresponding to step S1 is completed. Then, in step S2, the operation-and-display unit 11 receives input-operation requesting that scanning be started and then generates information (hereinafter, referred to as the scan-start request information) regarding operation-input requesting that scanning be started. The scan-start request information can be transmitted from the operation-and-display unit 11 by pressing a scan button provided on the operation-and-display unit 11 down, for example. After the scan-start request information is transmitted from the operation-and-display unit 11, the processing corresponding to step S2 is completed.

After the processing corresponding to step S2 is completed, the control unit 16 receives the scan-parameter setting information including scan-parameter and the scan-start request information, generates control information used for controlling the job-control unit 14, and transmits the control information to the job-control unit 14. Upon receiving job-start-control information transmitted from the control unit 16, the job-control unit 14 generates a job and transmits a signal requesting that the generated job be started to the control unit 16, at step S3.

After the job-control unit 14 starts performing the job, the control unit 16 generates control information requesting that the operation-and-display unit 11 enter a mode appropriate for receiving a cancellation request and transmits the control information to the operation-and-display unit 11. Upon receiving the above-described control information transmitted from the control unit 16, the operation-and-display unit 11 enters the cancellation-request-reception mode, at step S4.

After performing the above-described control so that the operation-and-display unit 11 enters the cancellation-request-reception mode, the control unit 16 generates control information requesting that the read unit 12 start scanning and transmits the generated control information to the read unit 12. Upon receiving control information transmitted from the control unit 16, where the control information requests that scanning for the first page be started, the read unit 16 starts the processing procedures (hereinafter, referred to as the scanning processing step) corresponding to steps S5 to S8, and steps S15 and S16.

First, the scanning processing step is started, at step S5. If the scanning corresponding to a single page is finished, the flow then proceeds to step S6. Upon receiving control information transmitted from the control unit 16, where the control information requests that scanning for the next page be started, that is to say, where the next document exists, the read unit 12 performs the scanning for the next page, at step S7. After the processing corresponding to step S7 is completed, the flow then proceeds to step S8. The processing procedures from step S8 on down include two types of processing procedures performed in parallel.

The details on one of the two types of processing procedures will be described, as below. Namely, after the processing corresponding to step S8 is completed, the flow goes back to step S6 so that the processing procedures corresponding to steps S6 to S8 are performed. The details on the other of the two types of processing procedures will be described, as below. Namely, after the processing corresponding to step S8 is completed, the flow proceeds to step S9 so that the processing procedures from step S9 on down are performed (mainly for OCR processing).

When the flow returns from step S8 to S6, the processing procedures from S6 on down are performed so that the scanning is continued until the last page comes. Then, the scanning operations are stopped, at step S15, and the scanning is finished, at step S16. Then, the job-control unit 14 waits until the OCR processing is completed, at step S17.

When the flow proceeds from step S8 to step S9, the control unit 16 generates control information used for controlling the job-control unit 14 so that information about a page scanned by the read unit 12 is stored. The generated control information is transmitted to the job-control unit 14, and the job-control unit 14 stores the scanned-page information, at step S9.

After the job-control unit 14 finishes storing information about the first page, at step S10, the processing corresponding to step S11 is performed. When the processing corresponding to step S10 is finished, the control unit 16 generates information used for controlling the OCR-processing unit 13, so as to start OCR processing. Upon receiving the generated control information transmitted from the control unit 16, the OCR-processing unit 13 performs the OCR processing corresponding to steps S11 to S14.

First, at step S11, the OCR-processing unit 13 performs OCR processing for the page information that had been stored, at step S9. When the OCR processing for the stored page information is finished, the flow proceeds to step S12 so that two types of processing procedures from step S12 on down are performed. The details on one of the two types of processing procedures will be described, as below. Namely, the flow proceeds to step S13 so that a display image of the result of the OCR processing performed, at step S11 is produced. The details on the other of the two types of processing procedures will be described, as below. Namely, the flow proceeds to step S14 so that the OCR processing is continued until the last page is OCR-processed.

When the flow proceeds from step S12 to step S13, the control unit 16 generates control information used for controlling the display element of the operation-and-display unit 11 so that the display element presents the OCR-result information and the image information to the user in a manner that the user can compare the OCR-result information to the image information. Upon receiving the control information transmitted from the control unit 16, the operation-and-display unit 11 presents the OCR-result information and the image information to the user so that they can be compared to each other by producing an image of the OCR result of an OCR-processed page and that of an image obtained by scanning in parallel, for example, at step S13.

On the other hand, where the flow proceeds from step S12 to step S14 and the next page exists, that is to say, where the next-page information is stored, at step S9, the flow proceeds to step S11 so that the next page is OCR processed. When the OCR processing for the last page is finished, the flow proceeds from step S14 to step S17.

When both the scan processing and the OCR processing are finished, at step S17, the flow proceeds to step S18. At that time, the control unit 16 receives a signal requesting that the job generation be finished and generates control information used for canceling the cancellation-reception mode of the operation-and-display unit 11.

Upon receiving the control information used for canceling the cancellation-reception mode transmitted from the control unit 16, the operation-and-display unit 11 cancels the cancellation-reception mode, at step S18. Subsequently, the job-control unit 14 finishes the job, at step S19. Subsequently, the above-described series of processing procedures shown in FIG. 2 are completed (END).

On the other hand, when the cancellation request is issued, as shown in FIG. 3, processing procedures from the start to step S13 where the display image of an OCR result is produced are the same as those performed under the normal conditions. Note that, in FIG. 3, the same processing procedures as those shown in FIG. 2 are designated by the same step numbers and the description thereof will not be provided.

In the event that the user performs an operation input requesting that OCR processing be cancelled based on the OCR result, and the operation-and-display unit 11 receives information about the operation input, at step S21. Then, the operation-and-display unit 11 transmits operation information requesting that the OCR processing be cancelled to the control unit 16.

Subsequently, the control unit 16 generates control information requesting that scan processing performed by the read unit 12 be stopped and information requesting that the currently executed job be completed based on the control information transmitted from the operation-and-display unit 11. Further, the control unit 16 transmits the control information to the read unit 12 and the job-termination information to the job-control unit 14. Upon receiving the scan-stop control information, the read unit 12 accepts that the scanning should be stopped, at step S22, and the job-control unit 14 accepts that the job should be stopped, at step S23.

Subsequently, the read unit 12 stops scanning, at step S24, so that the scanning is forcefully finished, at step S25. In addition, the job-control unit 14 stops performing the job, at step S14, and the flow proceeds to step S26.

When it is confirmed that both the scanning and the OCR processing are finished, at step S26, the flow then proceeds to step S27 so that the job-control unit 14 abandons the data generated by performing the processing procedures corresponding to steps S1 to S26. After the data is abandoned, at step S27, the flow proceeds to step S19. Subsequently, the job is finished, and all the processing procedures are finished (END).

In FIG. 3, the job-control unit 14 abandons the data, at step S27. At that time, however, a display image adapted to ask the user whether or not the data should be abandoned may be produced.

According to the above-described OCR method, the result of OCR processing (OCR-result information) performed in parallel with scanning and a scanned image (image information) are presented to the user in a manner that the user can compare the OCR-result information to the image information. Further, when a cancellation request is issued, both the OCR processing and the scanning are stopped. Therefore, it becomes possible to prevent the OCR system 10 from being placed under a heavier load than is necessary and reduce the time and trouble required for performing the scanning and/or the OCR processing again.

Thus, according to the above-described OCR system and OCR method, an image (image information) obtained by scanning and an OCR result (OCR information) are shown in parallel on the display element of the operation-display unit 11, when the OCR processing for the first page is finished. Subsequently, it becomes possible to inform a user of a decrease in the rate of optical-character recognition without delay, the decrease being caused by a flaw in read settings, and reduce the time and trouble required for performing the scanning and/or the OCR processing again.

Further, in the event that the OCR rate decreases due to the flaw in the read settings, the OCR processing can be cancelled even as the scanning is performed. Therefore, it becomes possible to prevent the OCR system from being put under a heavier load than is necessary.

What is claimed is:

1. An optical-character-recognition system comprising:
an operation unit configured to receive input-operation input from a user;
a display unit configured to visually present information to the user;
a read unit configured to perform conversion processing, so as to convert information provided on a document to image information;
an optical-character-recognition unit configured to perform character-information-acquisition processing, so as to acquire character information by subjecting the image information to optical-character-recognition processing;
a job-control unit configured to control an operation performed by each of the read unit and the optical-character-recognition unit; and
a control unit configured to control the operation unit, the display unit, the read unit, the optical-character-recognition unit, and the job-control unit,
wherein said control unit performs control so that the display unit shows an image based on the image information and the acquired character information representing a first page of the document in a predetermined manner, and wherein in case of receiving the input-operation information requesting for cancellation from the operation unit, said control unit performs control so that the read unit stops performing the conversion processing and the optical-character-recognition unit stops performing the character-information-acquisition processing.

2. The optical-character-recognition system according to claim 1, wherein said control unit is configured to perform control so that the display unit shows the image on the basis of the image information and the image acquired on the basis of the character information in parallel.

3. The optical-character-recognition system according to claim 1, wherein in a event that a value of a character-recognition rate for a predetermined page is lower than a threshold value representing a predetermined character-recognition rate, said control unit performs control so that the display unit highlights at least one of areas and characters in the displayed page, corresponding to the character-recognition-rate value lower than the threshold value.

4. The optical-character-recognition system according to claim 1, wherein said control unit performs control so that the display unit automatically switches from the image displayed on the basis of the image information and the acquired character information representing the first page of the document to image displayed on the basis of the image information and the acquired character information representing a next page of the document after a predetermined time period elapses.

5. The optical-character-recognition system according to claim 1, wherein said control unit performs control so that the display unit switches from the image displayed on the basis of the image information and the acquired character information representing the first page of the document to image displayed on the basis of the image information and the acquired character information representing a next page of the document after the operation unit receives the input-operation information including a request for page switching.

6. The optical-character-recognition system according to claim 1, wherein, every time the operation unit receives the input-operation information including a request for mode switching, said control unit performs control, so as to switch between a first mode in which the display unit automatically shows the image displayed on the basis of the image information and the acquired character information representing the first page of the document to image displayed on the basis of the image information and the acquired character information representing a next page of the document after a predetermined time period elapses and a second mode in which the display unit switches from the image displayed on the basis of the image information and the acquired character information representing the first page of the document to image displayed on the basis of the image information and the acquired character information representing a next page of the document after the operation unit receives the input-operation information including a request for page switching.

7. An optical-character-recognition method, comprising the steps of:
converting information including at least character information, provided on a document to image information;
performing optical-character-recognition processing so as to acquire character information on the basis of the image information until an input-operation information including a request for cancellation is received; and
stopping the converting step and the optical-character-recognition step without delay in a event that the input-operation information including the request for cancellation is received.

8. The optical-character-recognition method according to claim 7, wherein in the event that the input-operation information including the request for cancellation is received, said stopping step includes a step of confirming whether the acquired image information and character information should be abandoned or stored.

9. The optical-character-recognition method according to claim 7, wherein in a event that the operation unit receives the input-operation information including the request for cancellation, said stopping step includes a step of confirming whether the acquired image information and character information should be abandoned or stored, and a step of performing whether abandonment or storage of the acquired image information and character information based on a confirmation selected by user.
